(19) United States
(12) Patent Application Publication
(10) Pub. No.: US 2015/0177945 A1
(43) Pub. Date: Jun. 25, 2015

(54) ADAPTING INTERFACE BASED ON USAGE CONTEXT

(71) Applicants: Uttam K. Sengupta, Portland, OR (US); Aman Parnami, Atlanta, GA (US); Prashanth Kalluraya, Foster City, CA (US)

(72) Inventors: Uttam K. Sengupta, Portland, OR (US); Aman Parnami, Atlanta, GA (US); Prashanth Kalluraya, Foster City, CA (US)

(21) Appl. No.: 14/139,581

(22) Filed: Dec. 23, 2013

(51) Int. Cl. G06F 3/0488; G06F 3/044; G06F 3/0481

(52) U.S. Cl. CPC G06F 3/0488; G06F 3/04817; G06F 3/044

(57) ABSTRACT

Methods and apparatuses that present a user interface via a touch panel of a device are described. The touch panel can have touch sensors to generate touch events to receive user inputs from a user using the device. Sensor data may be provided via one or more context sensors. The sensor data can be related to a usage context of the device by the user. Context values may be determined based on the sensor data of the context sensors to represent the usage context. The user interface may be updated when the context values indicate a change of the usage context to adapt the device for the usage context.

### TECHNICAL FIELD

Embodiments of the present invention relate generally to interface adaptation. More particularly, embodiments of the invention relate to adjusting touch based user interface according to usage contexts identified.

### BACKGROUND ART

Mobile devices, including cellular phones, smart phones, tablets, mobile Internet devices (MIDs), handheld computers, personal digital assistants (PDAs), and other similar devices, provide a wide variety of applications for various purposes, including business and personal use.

A mobile device requires one or more input mechanisms to allow a user to input instructions and responses for such applications. As mobile devices become smaller yet more full-featured, a reduced number of user input devices (such as switches, buttons, trackballs, dials, touch sensors, and touch screens) are used to perform an increasing number of application functions.

Touch is the primary mode of user interaction on smart phones and tablets today. With the addition of gestures such as pinch-and-zoom, swipe, etc, users are able to interact much more efficiently and intuitively with apps on the device. However, interface and interaction design assumes the user is sedentary and using both hands on the touch panel of the device.

There are many situations where this assumption does not hold true—the user may be walking or running while using the device and even cases where the user is trying to use the device with one hand. Without the use of contextual information the responses to touch screen interactions are often inappropriate and sometimes frustrating. For example, if a user zooms in to a map with a pinch-out gesture while running the small text size remains unreadable and requires the user to stop, thus interrupting the activity.

Application developers may attempt to provide application level code to infer usage activities of smart phone devices directly from outputs of sensors embedded within these devices. However, sensor outputs accessible for applications of smart phone devices are usually limited for security, privacy or other reasons. For example, historical interaction data may not be accessible to applications. Further, separate applications may interpret sensor data in different manners to create non-standardized user experiences. Processing resources may be wasted or duplicated as multiple applications may compete for the same resources to infer usage activities.

Thus, traditional approaches for leveraging sensor data for mobile device usage information are not optimized, inconsistent, limited in capabilities and wasteful in processing resources.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating a system for adapting touch based user interface for usage contexts;

FIG. 2 is an illustration showing examples of usage contexts for mobile devices;

FIG. 3 is an illustration showing examples of a user interface updated according to usage contexts identified;

FIGS. 4A-4B are illustrations showing adjustments of touch interface for user contexts;

FIG. 5 is a flow diagram illustrating an exemplary process to adapt touch interface processing to match usage contexts;

FIG. 6 is a flow diagram illustrating one embodiment of a process to update user interface for a change of usage context;

FIG. 7 is a block diagram illustrating a mobile device according to one embodiment.

### DESCRIPTION OF THE EMBODIMENTS

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

Embodiments of the invention are generally directed to touch sensor gesture recognition for operation of mobile devices. As used herein:

“Mobile device” means a mobile electronic device or system including a cellular phone, smart phone, tablet, mobile Internet device (MID), handheld computers, personal digital assistants (PDAs), and other similar devices.

“Touch sensor” means a sensor that is configured to provide input signals that are generated by the physical touch of a user, including a sensor that detects contact by a thumb or other finger of a user of a device or system.

In some embodiments, a mobile device includes a touch sensor for the input of signals. In some embodiments, the touch sensor includes a plurality of sensor elements. In some embodiments, a method, apparatus, or system provides for: (1) A zoned touch sensor for multiple, simultaneous user interface modes; (2) Selection of a gesture identification algorithm based on an application; and (3) Neural network optical calibration of a touch sensor.

In some embodiments, a mobile device includes an instrumented surface designed for manipulation via a finger of a mobile device user. In some embodiments, the mobile device includes a sensor on a side of a device that may especially be accessible by a thumb (or other finger) of a mobile device user. In some embodiments, the surface of a sensor may be designed in any shape. In some embodiments, the sensor is constructed as an oblong intersection of a saddle shape. In some embodiments, the touch sensor is relatively small in comparison with the thumb used to engage the touch sensor.

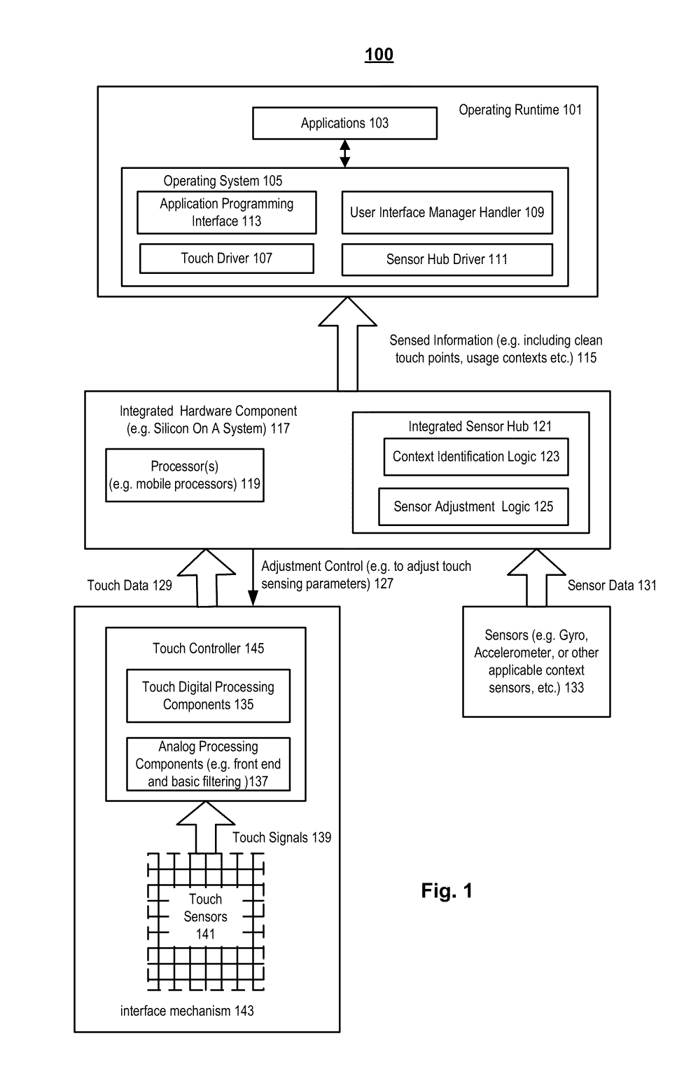

In some embodiments, instrumentation for a sensor is accomplished via the use of capacitance sensors and/or optical or other types of sensors embedded beneath the surface of the device input element. In some embodiments, these sensors are arranged in one of a number of possible patterns in order to increase overall sensitivity and signal accuracy, but may also be arranged to increase sensitivity to different operations or features (including, for example, motion at an edge of the sensor area, small motions, or particular gestures). Many different sensor arrangements for a capacitive sensor are possible, including, but not limited to, the sensor arrangements illustrated in FIG. 1 below.

In some embodiments, sensors include a controlling integrated circuit that is interfaced with the sensor and designed to connect to a computer processor, such as a general-purpose processor, via a bus, such as a standard interface bus. In some embodiments, sub-processors are variously connected to a computer processor responsible for collecting sensor input data, where the computer processor may be a primary CPU or a secondary microcontroller, depending on the application. In some embodiments, sensor data may pass through multiple sub-processors before the data reaches the processor that is responsible for handling all sensor inputs.

In one embodiment, user interface processing in mobile devices can incorporate contextual information or usage context for users of these devices to enable personalized responses or smart interactions. Usage context may indicate how a user is using a device to enhance interface usability with customized responses to touch screen interaction. Context information or usage context may be related to user activities, user vital statistics (e.g. user health readings), handedness (e.g. left handed or right handed), how a user is holding the device (with both hands or just one hand), whether a user is sedentary or moving (e.g., walking, running, driving), or other applicable usage information, etc.

The contextual information can be captured through sensors or context sensors on a device. Context sensors may include inertial sensors such as accelerometers, gyroscopes, or other applicable sensors. Sensor data may be analyzed in real time to distinguish between usage contexts, for example, associated with a user walking, running, lying on the bed or driving in a vehicle, etc. In some embodiments, the contextual information may be identified from historical data (or records) collected for a user and/or an analysis of the user's interaction patterns. The user's intent may also correspond to implicit input, such as contextual information inferred from these real time or historical data, to be applied for providing a smarter device interface and/or responses which are tailored for the user intent.

In one embodiment, an adaptive interface can integrate contextual information in a device to make usage context accessible to applications at a system level of the device. Capability of determining usage context or inferring contextual information can be an inherent part of the device. For example, operating systems (OS) and software development kit s(SDK) may expose these capabilities to developers to provide standardized user activity inference. An application may be aware of existing or changes to usage contexts of the device via an API (application programming interface), e.g. similar to accessing a touch event via a user interface API. As a result, contextually aware applications may be developed in an efficient and standard manner by leveraging the usage context provided via the APIs directly. Application code can incorporate usage contexts without a need for duplicating efforts to collect, analyze, and infer contextual information from different limited system sources.

FIG. 1 is a block diagram illustrating a system for adapting touch based user interface for usage contexts. System 100 may include integrated hardware component 117 (e.g. silicon on a system) coupled with interface mechanism 143, such as a touch interface peripheral. Operating runtime 101 may be hosted via integrated hardware component 117, for example in a memory device storing associated instructions and runtime data. One or more context sensors 133 may be coupled with integrated hardware component 117 to provide sensor data used for inferring usage context. Sensors 133 may include touch sensors for interface mechanism 143.

Clean touch points, e.g. represented by triplet (x, y, pressure) to indicate a touch location and pressure value, may be passed to host operating system 105 via touch driver 107. Operating system 105 can take these touch points and complete the processing to determine user intent, such as single tap, double tap, pinch-and-zoom, swipe, etc. Additionally, user activity contexts or usage contexts may be determined via integrated sensor hub 121 to allow processing of user inputs, such as touch inputs, to adapt inference of user intents based on the usage contexts.

Integrated hardware component 117 may include one or more processors 119, such as processors for mobile devices. In one embodiment, integrated hardware components can include integrated sensor hub 121 to aggregate or process sensor data 131 received from context sensors 133 in an integrated manner. Integrated sensor hub 121 may include context identification logic 123 to identify usage contexts from sensor data 131 or other data (e.g. history data or usage interaction patterns). In one embodiment, a usage context may be represented via a value of a context attribute. For example, a handedness context attribute may have one of two values indicating whether a user is using a device in a single handed or dual handed manner. Multiple context attributes may be configured in context identification logic 123 to represent usage contexts provided in sensed information 115 to operating environment 101.

In one embodiment, interface mechanism 143 can detect physical actions from a user using a device of system 100 to receive user inputs or intended inputs. Whether the user inputs are actually received can depend on sensitivity of interface mechanism 143, which may be configurable. For example, interface mechanism 143 can have one or more interface sensors, such as touch sensors 141 (e.g. in a touch panel) to generate touch signals 139 (or sensor signals) when receiving or sensing user's touch actions.

In one embodiment, interface mechanism 143 can include configuration settings which specify whether sensor signals 139 are converted to user inputs according to usage contexts 115 identified from sensor data 131. The configuration settings may be updated to change the sensitivity of interface mechanism 143. Integrated hardware components 117 can send adjustment control 127 to interface mechanism 143 to dynamically configure interface mechanism 143 according to usage contexts identified from sensor data 131.

In one embodiment, interface mechanism 143 can include touch controller 145 to process touch signals 139. Touch controllers 145 can include analog processing components 137 and digital processing components 135. Analog processing components may include front end and filtering circuits capable of filtering touch signals 139. Analog processing components 137 may be configured with parameters (e.g. resistance, capacitance settings) to filter noise signals received based on, for example, signal strength or other signal characteristics. The parameters may include voltage change sensitivity to represent amount of voltage change with respect to a change in distance between the user touch and touch sensors 141. The voltage change sensitivity can be decreased via the configuration settings if the usage context indicates that the user is operating the device in a wet environment (e.g. based on moisture detected from user's hands holding the device).

Digital processing components 135 may determine whether to generate touch data 129 from received touch signals 139 based on configuration settings of interface mechanism 143. In some embodiments, touch data 129 may include one or more touch points, each touch point characterized or represented by a location (e.g. (x, y) coordinate), pressure value and/or other applicable specifications for a touch event. The location may be provided to indicate where in the device a touch event occurs. In one embodiment, the configuration settings can include minimal signal strength to generate a touch event. The sensitivity of interface mechanism 143 may be increased when the minimal signal strength is decreased via the configuration settings, when, for example, the usage context indicates that the user is in motion.

In some embodiments, touch sensors 141 can have parameters configured via configuration settings of interface mechanism 143 to specify minimum hover distance between the device and the user touch to generate sensor signals 141. The sensitivity of interface mechanism 143 may be updated to increase the minimum hover distance via adjustment control 127 if usage contexts identified from sensor data 131 indicate that the user is in motion.

Sensors 133 can include one or more context sensors to provide sensor data related to a usage context characterizing a state of the usage of the device by a user. Context sensors 133 may include sensors to measure movement and orientation of the device (e.g. accelerometer), sensors to determine the direction of magnetic north, rotation of the device relative to magnetic north and/or detecting magnetic fields around the device (e.g. magnetometer) to provide location services. In some embodiments, context sensors 133 may include sensors to measure the angular rotation of the device on three different axes (e.g. gyroscope), proximity sensors (e.g. to prevent accidental selections during a call), ambient light sensors (e.g. to monitor the light levels in the device environment and adjust screen brightness accordingly), UV (ultra violet light) sensors, Hall Effect (lid closure) sensor, Touchless Motion sensors, humidity sensor, health stat (electrocardiogram/heart rate) sensors, haptics or tactile sensors, temperature sensors, grip detectors, chemical (e.g. air quality, pollutant, CO) sensors, Gamma Ray detector sensors, or other applicable sensors, etc.

In some embodiments, context sensors 133 may include one or more touch sensors of interface mechanism 143. Sensor data 131 collected may be independent of security or privacy constraints applied to applications 103. As a result, usage contexts can be accurately identified at a system level based on each context sensor coupled to a device without being limited to only a partial set of sensor data because of privacy policy applied at application level.

Context identification logic 123 can determine context values for one or more context attributes representing usage contexts based on sensor data 131 received from context sensors 133. Sensor adjustment logic 125 can update the sensitivity of interface mechanism 143, e.g. via adjustment control 127, according to the context values (or the usage contexts) determined. The updated sensitivity of interface mechanism 143 can automatically adapt user interactions (e.g. input/output) of the device according to the usage contexts identified to increase ease of use for the device.

For example, interface mechanism 143 can present a user interface (such as a graphical user interface on a display screen for user inputs. The user interface can include a layout (or user interface layout) of graphic elements (e.g. icons, buttons, windows or other graphical user interface patterns) allowing user manipulation via user inputs received via touch sensors 141. The layout may be generated via user interface manager handle 109 of operating system 105 hosted by integrated hardware components 117. In one embodiment, operating system 105 (or system logic) can automatically arrange or re-arrange the layout based on usage contexts identified, via, for example, user interface manager handler 109. In some embodiments, user interface manager handler 109 can determine whether to update existing layout when a change of usage contexts are detected via sensed information 115 provided by integrated sensor hub 121.

In one embodiment, graphic elements of the user interface layout displayed via interface mechanism 143 can include an icon associated with a boundary area encompassing the icon. User interface manager handler 109 can determine whether a touch event occurs on the icon for user inputs based on usage contexts. For example, the touch event may not occur on the icon if a location indicator of the touch event indicates that the touch event occurs outside of the boundary area associated with the icon. In one embodiment, the boundary area may be adjusted as a change of usage contexts is detected. For example, the boundary area can be enlarged if the change indicates that the user starts moving (e.g. walking, running, etc.) to provide wider real estate or display area for the user to touch the icon. Optionally or additionally, the size of the icon may be updated according to the usage contexts (e.g. enlarged when the user starts moving).

In certain embodiments, the graphics elements (e.g. application or service icons) in the user interface layout may be arranged in a two dimensional manner when the usage contexts indicate a dual handed use of the device. Alternatively, the graphics elements may be displayed in a one dimensional manner if the usage contexts indicate a single handed use of the device.

Additionally, the graphics elements may be arranged on a left side of the device if the usage contexts indicate that the user uses the device single handed via a left hand. Similarly, the graphics elements may be arranged on a right side of the device if the usage contexts indicate that the user uses the device single handedly via a right hand. As usage contexts change, layout arrangements of the graphics elements may change accordingly.

In one embodiment, operating runtime 101 may include applications 103 and/or services which may be activated by a user via touch interface mechanism 143. Operating runtime 101 may include sensor hub driver 111 to enable operating system 105 to access usage contexts from integrated sensor hub 121 via sensed information 115. Alternatively or additionally, operating runtime 101 may include touch driver 107 to allow accessing touch points detected from touch interface mechanism 143 via sensed information 115. Operation system 105 may provide application programming interface 113 to allow applications 103 to access usage contexts for adapting application 103 to changes of the usage contexts without requiring applications 103 to identify these usage contexts from raw sensor data.

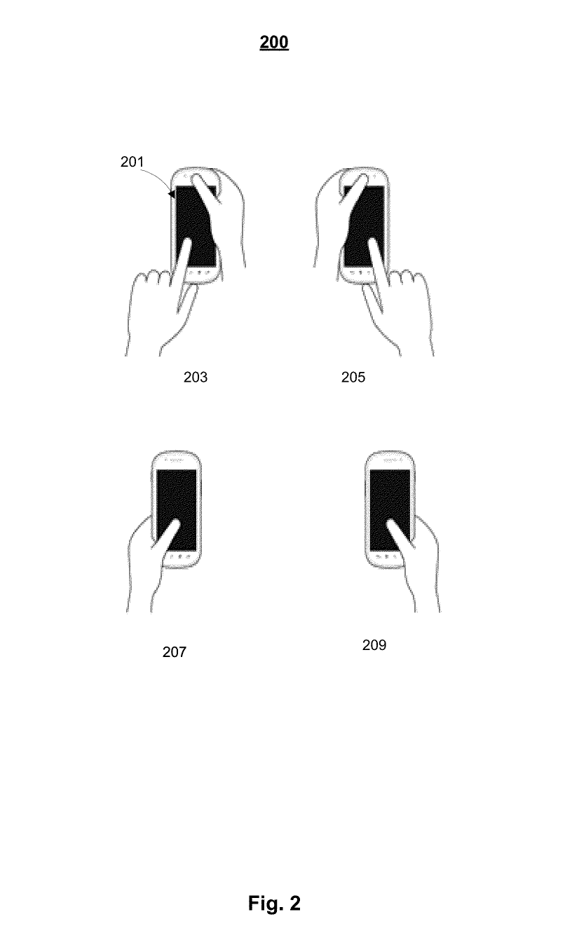

FIG. 2 is an illustration showing examples of usage contexts for mobile devices. For example, device 201 may be operated via a user based on system 100 of FIG. 1. Usage contexts for usage examples 203 and 205 may indicate dual handed use in a sedentary manner (e.g. sitting down or standing still). Usage contexts for usage examples 207 and 209 may indicate single handed use in a moving manner (e.g. running, walking, in bus/train with one hand holding on). Additionally, usage contexts for usage example 207 may indicate left handed use and usage contexts for usage example 209 may indicate right handed use.

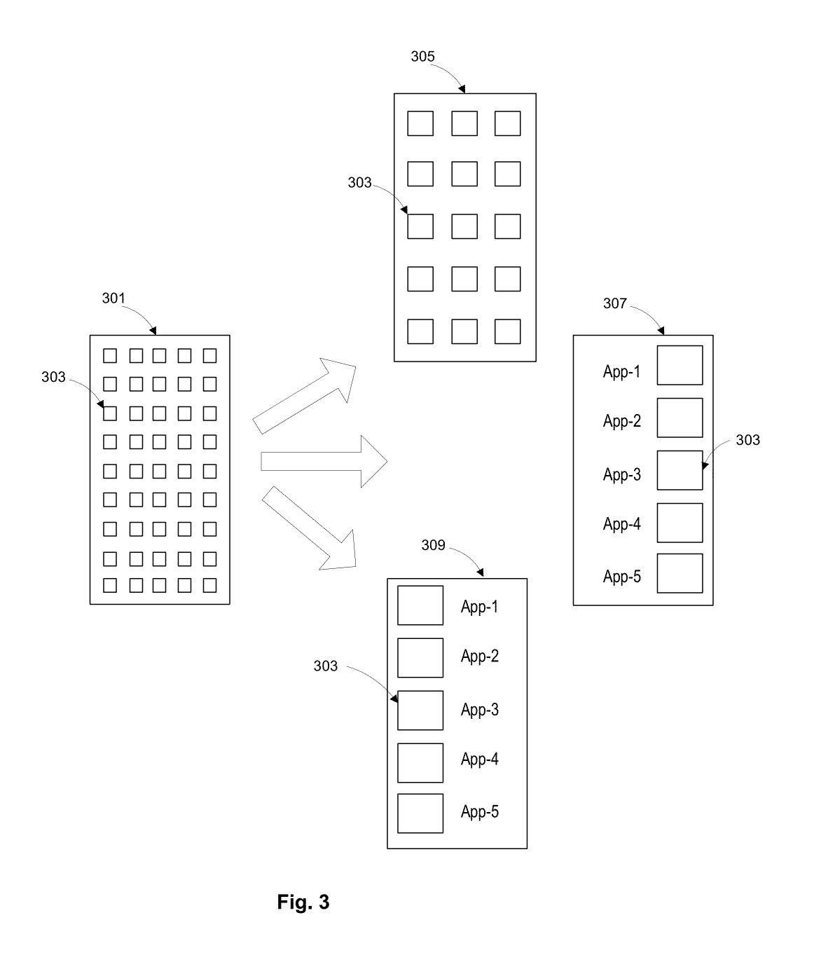

FIG. 3 is an illustration showing examples of a user interface updated according to usage contexts identified. For example, interface 301 may be presented via a mobile device based on system 100 of FIG. 1. Interface 301 may include multiple icons, such as icon 303, arranged in a two dimensional manner representing separate applications or services which can be activated when touch actions on interface 301 are received on corresponding icons. In one embodiment, interface 301 may correspond to a default user interface layout for a normal usage context when a device is being held by both hands of a user when the user is sedentary (e.g. standing still, sitting down).

Interface 305 may represent an updated user interface layout for a usage context indicating the user is in motion. For example, icon 303 may be enlarged compared with interface 301. Inter-icon spacing may also be increased to allow easier access to different icons when the user is moving. Usage contexts for interface 301, 305 may indicate the user is using the device with both hands. In some embodiments, if usage contexts indidate a tight grip of the device used in motion (e.g. for using a large sized device when running), user interface may be adapted for dual handed use to increase device usability as single handed use tends to be difficult when users are in motion.

In some embodiments, interfaces 309, 307 may be presented for usage contexts indicating single handed use of the device when the user is in motion, such as in examples 207, 209 of FIG. 2. Icons may be arranged in a one dimensional (vertical) manner accompanied by naming texts with large enough font sizes for clarity. Interface 307 and interface 309 may correspond to updated interfaces respectively for a right handed use and a left handed use.

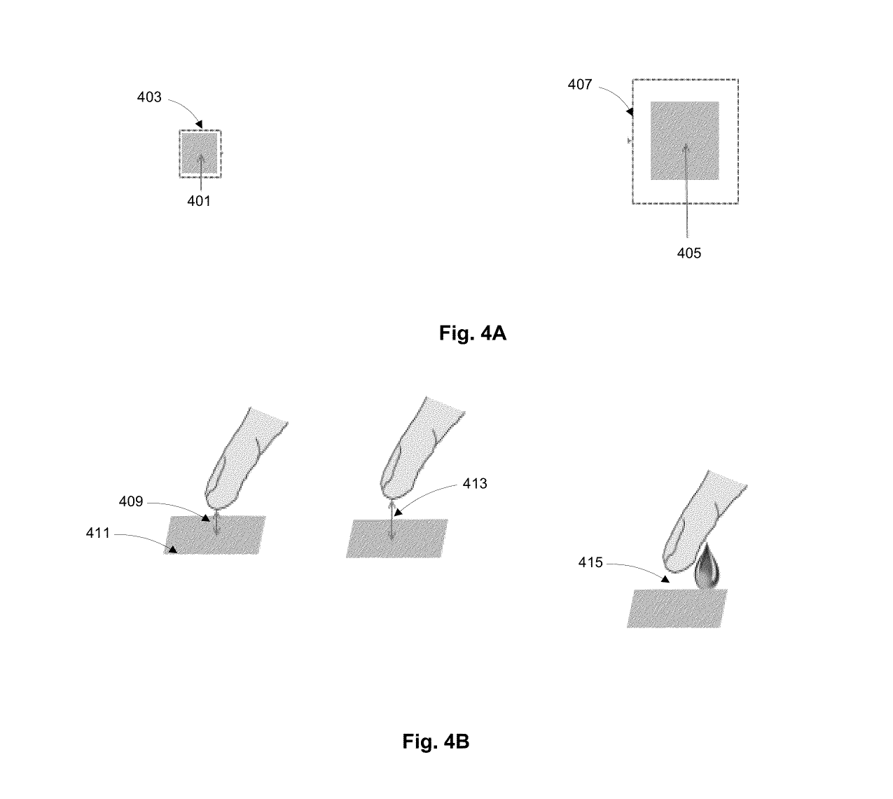

FIGS. 4A-4B are illustrations showing adjustments of touch interface for user contexts. For example, illustration 400 may be based on interface mechanism 143 of FIG. 1. Turning now to FIG. 4A, as shown, icon 401 may be associated with a encompassing boundary 403 to determining whether a touch point identified from touch sensors, such as in touch sensors 141 of FIG. 1, corresponds to a touch event on icon 401. Boundary 403 may correspond to a touch sensitivity boundary for icon 401. In one embodiment, a touch event may be created for icon 401 if a touch point is located within boundary 403. Icon 401 may be presented for usage contexts indicating a normal mode when a user uses the device with both hands (e.g. via index finger) in a sedentary manner.

Icon 405 and boundary 407 may be presented for usage contexts indicating that the user is in motion (e.g. running) and/or using the device single handedly (e.g. with a thumb). Icon size may be increased and boundary sensitivy may be relaxed for icon 405 and boundary 407 compared with icon 401 and boundary 403.

Turning now to FIG. 4B, touch signals may be generated according to hovering distance 409 between icon surface 411, such as display surface associated with a panel of touch sensors 141 of FIG. 1. Parameters of touch sensors, such as capacitive touch panels, may be adjustable to specify a range of hover distance to generate touch signals according to usage contexts. For example, hover distance 409 may correspond to a normal usage mode when the user is sedentary. As the user starts to move (e.g. in a car/train or driving), hover distance may be increased, such as hover distance 413, to increase sensitivity of the touch sensors.

In some embodiments, sensitivity of touch sensors may be adjusted depending on whether the usage contexts indicate whether the device is used in a wet or dry environment. In this scenario, the on-board humidity sensors on the device can determine the level of humidity. For example, parameter settings of an interface mechanism, such as touch capacitive properties 415, may be adjusted or adapted to accommodate touch actions applied via a sweaty or wet finger. Parameter settings may be automatically updated to allow the user to use the device in a similar way regardless whether in a wet or dry environment.

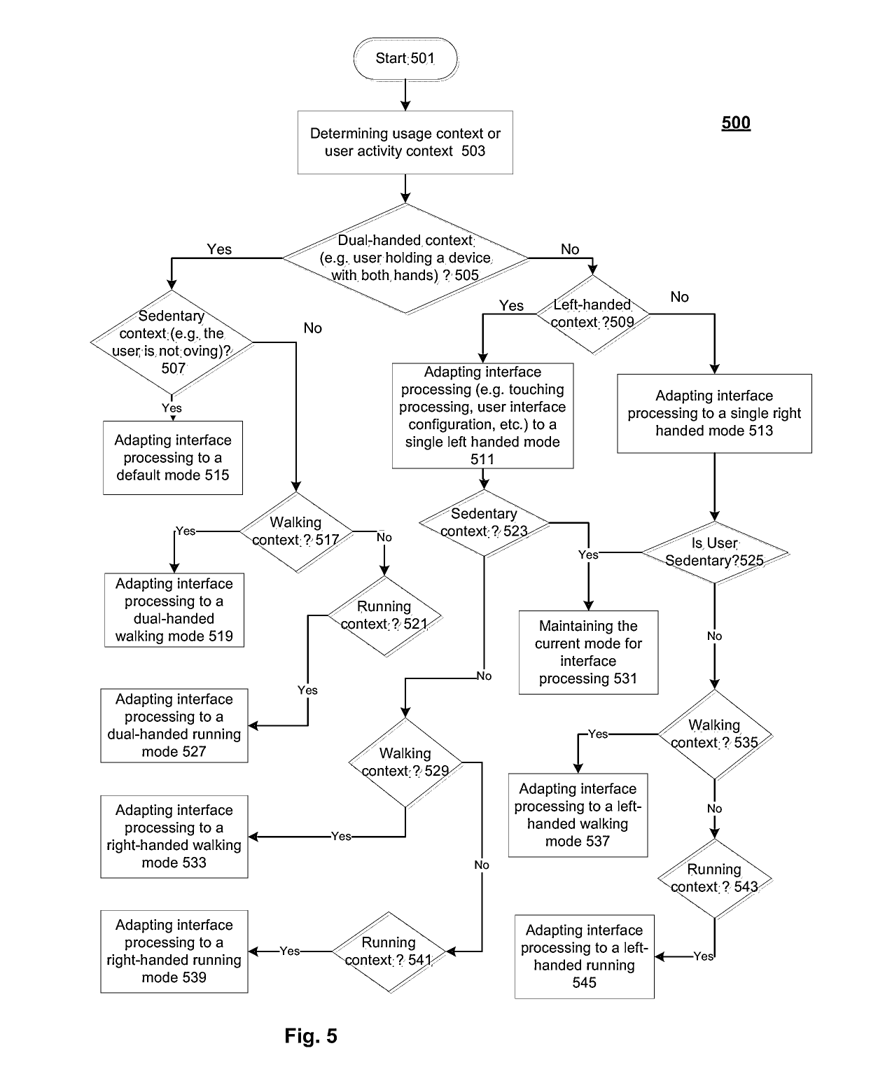

FIG. 5 is a flow diagram illustrating an exemplary process to adapt touch interface processing to match usage contexts. Exemplary process 500 may be performed by a processing logic that may include hardware (circuitry, dedicated logic, etc.), software (such as is run on a dedicated machine), or a combination of both. For example, process 300 may be performed by some components of system 100 of FIG. 1. At block 301, for example, processing logic of process 500 may be triggered by sensor signals received, such as sensor data 131 of FIG. 1. Alternatively or additionally, processing logic of process 500 may be performed periodically via a configured schedule to maintain current usage contexts for a device.

At block 503, the processing logic of process 500 can determine context values for a plurality of usage contexts. At block 505, for example, the processing logic of process 500 can identify whether the usage contexts include a dual-handed context, such as in usage examples 203, 205 of FIG. 2. If the usage contexts indicate a single handed use, the processing logic of process 500 can determine whether the usage contexts indicate a left handed use of the device or a right handed use of the device at block 509.

If the usage contexts indicate a left-handed use, at block 511, the processing logic of process 500 can adapt user interface processing including, for example, graphic user interface presentation layout and touch input processing, to a single left handed mode. Alternatively, at block 513, if the usage contexts indicate a right handed use, the processing logic of process 500 can adapt user interface processing to a single right handed mode, such as interface 307 of FIG. 3. At block 525, the processing logic of process 500 can determine whether the user is sedentary. If the user is determined to be sedentary using the device, the processing logic of process can maintain current interface processing at block 531.

If the user is determined to be in motion, at block 535, the processing logic of process 500 can determine whether the usage contexts indicate the user is walking. If the user is walking, at block 537, the processing logic of process 500 can adapt interface processing to a left handed walking mode, such as interface 309 of FIG. 3. Otherwise, at block 543, the processing logic of process 500 can determine whether the user is running. If the user is running, at block 545, the processing logic of process 500 can update interface processing to a left handed running mode.

At block 523, the processing logic of process 500 can determine whether the user is in motion or stays still. If the usage contexts indicate the user is sedentary, the processing logic of process 500 can maintin current interface processing without making changes at block 531. If the user is in motion, at block 529, the processing logic of process 500 can determine whether the user is walking. If the usage contexts indicate the user is walking, at block 533, the processing logic of process 500 can adapt interface processing to a right handed walking mode, such as interface 307 of FIG. 3. At block 541, the processing logic of process 500 can determine if the user is running. If the usage contexts indicate the user is running, at block 539, the processing logic of process 500 can adapt the interface processing to a right handed running mode.

At block 507, the processing logic of process 500 can determine whether the user is moving. If the user is not moving, at block 515, the processing logic of process 500 can adapt the interface processing to a default mode, such as interface 301 of FIG. 3. If the user is not sedentary, at block 517, the processing logic of process 500 can determine whether the user is walking. If the usage contexts indicate the user is walking using the device, at block 519, the processing logic of process 500 can update the interface processing to a dual handed walking mode, such as interface 305 of FIG. 3. Otherwise, the processing logic of process 500 can determine whether the usage contexts indicate the user is running at block 521. If the usage contexts indicate the user is carrying the device running, the processing logic of process 500 can update the interface processing to a dual handed running mode at block 527.

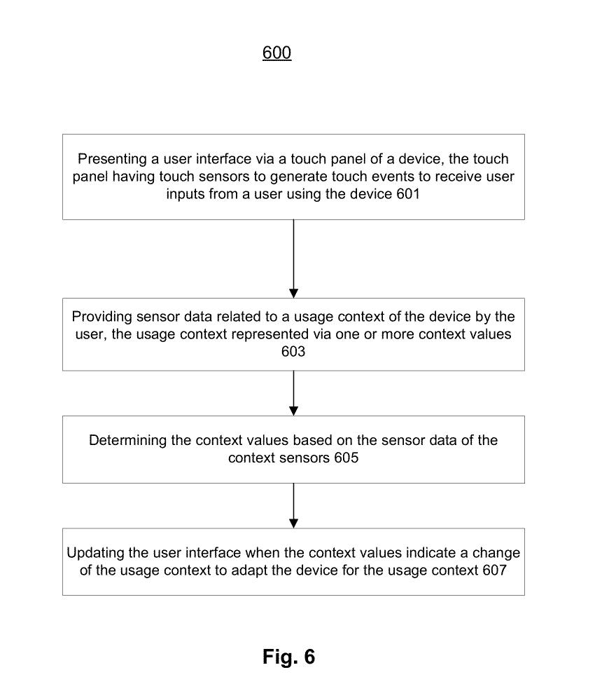

FIG. 6 is a flow diagram illustrating one embodiment of a process to update user interface for a change of usage context. Exemplary process 600 may be performed by a processing logic that may include hardware (circuitry, dedicated logic, etc.), software (such as is run on a dedicated machine), or a combination of both. For example, process 600 may be performed by some components of system 100 of FIG. 1.

At block 601, the processing logic of process 600 can present a user interface via a touch panel of a device, such as in touch interface mechanism 143 of FIG. 1. The touch panel can have touch sensors, such as touch sensors 141 of FIG. 1, to generate touch events to receive user inputs from a user using the device. At block 603, the processing logic of process 600 can provide sensor data, such as sensor data 131 of FIG. 1, via one or more context sensors. The context data may be related to a usage context of the device by the user. The usage context can be represented via one or more context values associated with context attributes.

At block 605, in one embodiment, the processing logic of process 600 can determine the context values based on the sensor data of the context sensors. At block 607, the processing logic of process 600 can update the user interface when the context values indicate a change of the usage context has occurred (or just occurred in real time). As a result, interface processing of the device may be adapted automatically to match current usage contexts of the user without a need for explicit instructions from the user.

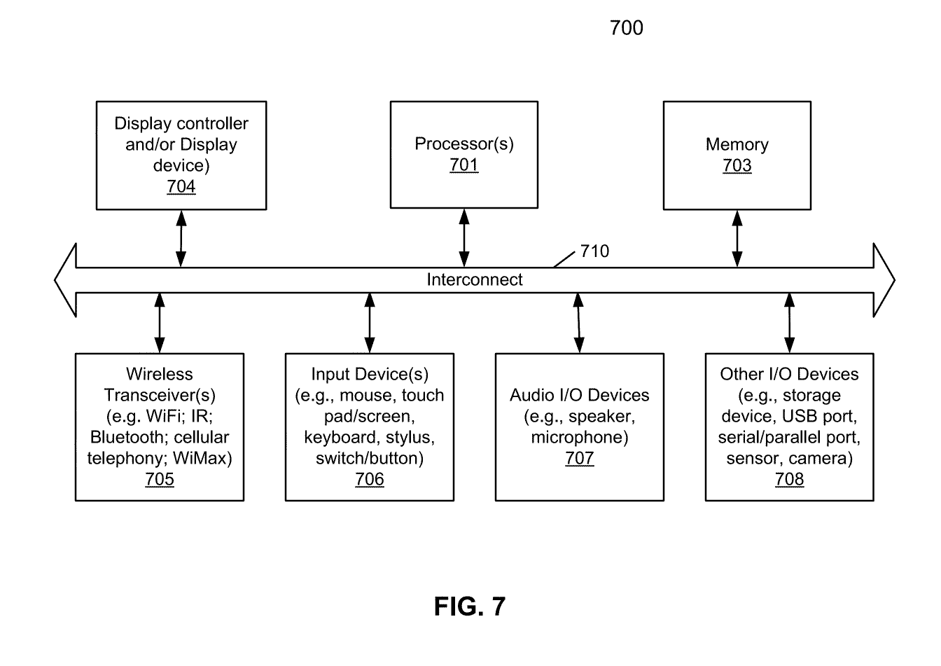

FIG. 7 is a block diagram illustrating an example of a data processing system which may be used with one embodiment of the invention. For example, system 700 may represents any of data processing systems described above performing any of the processes or methods described above. System 700 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 700 is intended to show a high level view of many components of the computer system. However, it is to be understood that additional components may be present in certain implementations and furthermore, different arrangement of the components shown may occur in other implementations. System 700 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof.

In one embodiment, system 700 includes processor 701, memory 703, and devices 705-708 via a bus or an interconnect 710. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 701, which may be a low power multi-core processor socket such as an ultra low voltage processor, may act as a main processing unit and central hub for communication with the various components of the system. Such processor can be implemented as a system on chip (SoC). In one embodiment, processor 701 may be an Intel® Architecture Core™-based processor such as an i3, i5, i7 or another such processor (e.g., Atom) available from Intel Corporation, Santa Clara, Calif. However, other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments.

Processor 701 is configured to execute instructions for performing the operations and steps discussed herein. System 700 further includes a graphics interface that communicates with graphics subsystem 704, which may include a display controller and/or a display device.

Processor 701 may communicate with memory 703, which in an embodiment can be implemented via multiple memory devices to provide for a given amount of system memory. As examples, the memory can be in accordance with a Joint Electron Devices Engineering Council (JEDEC) low power double data rate (LPDDR)-based design such as the current LPDDR2 standard according to JEDEC JESD 209-2E (published April 2009), or a next generation LPDDR standard to be referred to as LPDDR3 that will offer extensions to LPDDR2 to increase bandwidth. As examples, 2/4/8 gigabytes (GB) of system memory may be present and can be coupled to processor 810 via one or more memory interconnects. In various implementations the individual memory devices can be of different package types such as single die package (SDP), dual die package (DDP) or quad die package (QDP). These devices can in some embodiments be directly soldered onto a motherboard to provide a lower profile solution, while in other embodiments the devices can be configured as one or more memory modules that in turn can couple to the motherboard by a given connector.

Memory 703 may include one or more volatile storage (or memory) devices such as random access memory (RAM), dynamic RAM (DRAM), synchronous DRAM (SDRAM), static RAM (SRAM), or other types of storage devices. Memory 703 may store information including sequences of instructions that are executed by processor 701, or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 700 may further include IO devices such as devices 705-708, including wireless transceiver(s) 705, input device(s) 706, audio IO device(s) 707, and other IO devices 708. Wireless transceiver 705 may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof.

Input device(s) 706 may include a mouse, a touch pad, a touch sensitive screen (which may be integrated with display device 704), a pointer device such as a stylus, and/or a keyboard (e.g., physical keyboard or a virtual keyboard displayed as part of a touch sensitive screen). For example, input device 706 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO device 707 may include a speaker and/or a microphone to facilitate voice-enabled functions, such as voice recognition, voice replication, digital recording, and/or telephony functions. Other optional devices 708 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Optional devices 708 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 710 via a sensor hub (not shown), while other devices such as a keyboard or thermal sensor may be controlled by an embedded controller (not shown), dependent upon the specific configuration or design of system 700.

To provide for persistent storage of information such as data, applications, one or more operating systems and so forth, a mass storage (not shown) may also couple to processor 701. In various embodiments, to enable a thinner and lighter system design as well as to improve system responsiveness, this mass storage may be implemented via a solid state device (SSD). However in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 701, e.g., via a serial peripheral interface (SPI). This flash device may provide for non-volatile storage of system software, including a basic input/output software (BIOS) as well as other firmware of the system.

Note that while system 700 is illustrated with various components of a data processing system, it is not intended to represent any particular architecture or manner of interconnecting the components; as such details are not germane to embodiments of the present invention. It will also be appreciated that network computers, handheld computers, mobile phones, and other data processing systems which have fewer components or perhaps more components may also be used with embodiments of the invention.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g. circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

1. A mobile device system comprising:
an interface mechanism to detect physical actions from a user to receive user inputs, the user inputs to be received via the physical actions based on sensitivity of the interface mechanism;
one or more context sensors to provide sensor data related to a usage context of the device by the user;
context identification logic to determine context values based on the sensor data of the context sensors; and
adjustment logic to adjust the sensitivity of the interface mechanism according to the context values for the user to interface with the device in the usage context.

2. The system of claim 1, wherein the interface mechanism has one or more interface sensors to generate sensor signals from the physical actions, wherein the interface mechanism includes configuration settings for converting the sensor signals to the user inputs, and wherein the sensitivity is updated to change the configuration settings to specify whether the sensor signals are converted to the user inputs according to the usage context.

3. The system of claim 2, wherein the interface mechanism includes analog processing components capable of filtering the sensor signals, the sensor signals to be filtered via the analog processing components based on the configuration settings.

4. The system of claim 3, wherein the configuration settings include a minimal signal strength to filter the sensor signals and wherein the sensitivity of the interface mechanism is increased when the minimal signal strength is decreased if the usage context indicates that the user is in motion.

5. The system of claim 4, wherein the interface sensors include touch sensors having parameters configured via the configuration settings to specify minimum hover distance between the system and the user to generate the sensor signals, and wherein the sensitivity is updated to increase the minimum hover distance if the usage context indicates that the user is in motion.

6. The system of claim 5, wherein the parameters include voltage change sensitivity to represent amount of voltage change with respect to a change in distance between the user and the touch sensors and wherein the voltage change sensitivity is decreased via the configuration settings if the usage context indicates that the user operates the system in a wet environment.

7. The system of claim 2, wherein a user interface is presented via the interface mechanism for the user inputs, wherein the user interface includes a layout of a plurality of graphic elements allowing manipulation via the user inputs, further comprising:
system logic to arrange the layout for the user interface based on the context values of the usage context, wherein the system logic determines whether to update the layout when the usage context changes.

8. The system of claim 7, wherein the interface mechanism includes digital processing components to provide representation of a touch event from the sensor signals, wherein the representation includes a location indicator indicating where the touch event occurs on the system.

9. The system of claim 8, wherein the graphic elements include an icon displayed via the interface mechanism, wherein the icon is associated with a boundary area encompassing the icon displayed, wherein the system logic determines whether the touch event occurs on the icon for the user inputs based on the usage context, wherein the touch event does not occur on the icon if the location indicator indicates that the touch event occurs outside of the boundary area associated with the icon.

10. The system of claim 9, wherein the boundary area is adjusted according to a change of the usage context and wherein the boundary area is enlarged if the change indicates the user starts moving.

11. The system of claim 9, wherein size of the icon is adjusted according to a change of the usage context and wherein the size of the icon is enlarged if the change indicates the user starts moving.

12. The system of claim 7, wherein the usage context indicates a dual handed usage of the system and wherein the graphic elements are displayed in a two dimensional manner according to the layout.

13. The system of claim 7, wherein the usage context indicated a single handed usage of the system and wherein the graphic elements are displayed in a one dimensional manner according to the layout.

14. The system of claim 13, wherein the usage context indicates a left handed usage of the system and wherein the graphics elements are displayed along left side of the system according to the layout.

15. An apparatus comprising:
logic, a portion of which is at least partially implemented in hardware, to:
determine the context values based on sensor data related to a usage context of a mobile device by a user; and
adjust a sensitivity of a physical interface mechanism of the mobile device according to the context values.

16. The apparatus of claim 15, wherein the physical interface mechanism generates touch events to receive user inputs from the user and wherein whether the touch event are generated are based on the sensitivity.

17. The apparatus of claim 16, wherein a user interface is presented via the physical interface mechanism, the user interface including a layout of a plurality of graphic elements allowing manipulation via the user inputs, and wherein the layout for the user interface is arranged based on the context values of the usage context.

18. The apparatus of claim 17, wherein a touch event includes a location indicator indicating where the touch event occurs, wherein the graphic elements include an icon associated with a boundary area encompassing the icon, and wherein the portion of the logic is implemented further to:
determine whether the touch event occurs on the icon for the user inputs based on the usage context, wherein the touch event does not occur on the icon if the location indicator indicates that the touch event occurs outside of the boundary area associated with the icon.

19. The apparatus of claim 16, wherein sensor signals are generated via the physical interface mechanism and wherein the sensor signals are filtered based on the sensitivity adjusted via the usage context.

20. A non-transitory machine-readable non-transitory storage medium having instructions therein, which when executed by a machine, causes the machine to perform operations, the operations comprising:
presenting a user interface via a touch panel of a device, the touch panel having touch sensors to generate touch events to receive user inputs from a user using the device;
providing sensor data via one or more context sensors, the sensor data related to a usage context of the device by the user, the usage context represented via one or more context values;
determining the context values based on the sensor data of the context sensors; and
updating the user interface when the context values indicate a change of the usage context to adapt the device for the usage context.

21. The medium of claim 20, wherein whether the touch event are generated are based on sensitivity of the touch panel, further comprising:
configuring the sensitivity of the touch panel according to the usage context.

22. The medium of claim 21, wherein the user interface includes a layout of a plurality of graphic elements allowing manipulation via the user inputs, further comprising:
arranging the layout for the user interface based on the context values of the usage context, wherein the layout is rearranged for the update of the user interface.

23. The medium of claim 22, wherein representation of a touch event includes a location indicator indicating where the touch event occurs on the touch panel, wherein the graphic elements include an icon associated with a boundary area encompassing the icon, further comprising:
determining whether the touch event occurs on the icon for the user inputs based on the usage context, wherein the touch event does not occur on the icon if the location indicator indicates that the touch event occurs outside of the boundary area associated with the icon.

24. The medium of claim 21, wherein sensor signals are generated via the touch sensors, further comprising:
filtering the sensor signals based on the sensitivity configured via the usage context.

25. The system of claim 7, wherein the system logic includes one or more processors configured to perform data processing operations for the arrangement of the layout for the user interface.

26. The system of claim 2, wherein the interface sensors include a capacitive touch array integrated in a display screen.
